(19) United States
(12) Patent Application Publication
(10) Pub. No.: US 2012/0069041 A1
(43) Pub. Date: Mar. 22, 2012

(54) IMAGE PROCESSING APPARATUS, IMAGE FORMING APPARATUS, IMAGE PROCESSING METHOD, IMAGE FORMING METHOD, AND NON-TRANSITORY COMPUTER READABLE RECORDING MEDIUM

(75) Inventors: Atsushi KITAGAWARA, Kanagawa (JP); Hidetoshi KAWASHIMA, Kanagawa (JP); Toshio KOORIYAMA, Kanagawa (JP)

(73) Assignee: FUJI XEROX CO., LTD., Tokyo (JP)

(21) Appl. No.: 13/096,536

(22) Filed: Apr. 28, 2011

(30) Foreign Application Priority Data
Sep. 22, 2010 (JP) 2010-212704

(51) Int. Cl. G09G 5/02

(52) U.S. Cl. 345/589

(57) ABSTRACT

According to an aspect of the invention, an image processing apparatus includes a graphic registration unit, a registered graphic extraction unit, a color reduction unit and an image formation controller. A specific graphic is registered in the graphic registration unit. The registered graphic extraction unit extracts, from an image to be processed, the specific graphic registered in the graphic registration unit. The color reduction unit reduces the number of colors used for a portion of the image to be processed other than the specific graphic. The image formation controller controls an image forming apparatus to form the specific graphic and the portion of the image to be processed in which the number of the colors is reduced, according to a performance of the image forming apparatus.

### CROSS-REFERENCE TO RELATED APPLICATIONS

This application is based on and claims priority under 35 USC 119 from Japanese Patent Application No. 2010-212704 filed on Sep. 22, 2010.

### BACKGROUND

1. Technical Field

The present disclosure relates to an image processing apparatus, an image forming apparatus, an image processing method, an image forming method, and a non-transitory computer readable recording medium storing a program that cases a computer to execute image processing or image formation.

2. Related Art

As an image forming apparatus, there are an apparatus using color materials of two colors, an apparatus that forms a full-color image using color materials of, for example, four or more colors, as well as an apparatus that forms an image with a single color. For example, even in the case where an image forming apparatus which forms an image using color materials of four or more colors is used, there may be a case where an image is formed with two colors or a single color in order to reduce an amount of the used color materials and costs.

For example, there is a need to faithfully reproduce a color for a specific graphic such as an emblem (for example, so called corporate logo) and seal impression. However, when the image is formed with colors being reduced to two colors or a single color, even though the image forming apparatus has a performance of forming a full-color image, the specific graphic and the other portions are formed with the reduced color(s).

### SUMMARY

According to an aspect of the invention, an image processing apparatus includes a graphic registration unit, a registered graphic extraction unit, a color reduction unit and an image formation controller. A specific graphic is registered in the graphic registration unit. The registered graphic extraction unit extracts, from an image to be processed, the specific graphic registered in the graphic registration unit. The color reduction unit reduces the number of colors used for a portion of the image to be processed other than the specific graphic. The image formation controller controls an image forming apparatus to form the specific graphic and the portion of the image to be processed in which the number of the colors is reduced, according to a performance of the image forming apparatus.

### BRIEF DESCRIPTION OF THE DRAWINGS

Exemplary embodiments of the invention will be described in detail below based on the accompanying drawings, wherein:

FIG. 1 is a configuration diagram showing an exemplary embodiment of the invention;

FIG. 2 is a diagram for explaining a specific example of an operation of the exemplary embodiment of the invention;

FIG. 3A to 3C are diagrams for explaining a specific example of an operation in the exemplary embodiment of the invention (continuation of the explanation in FIG. 2);

FIG. 4 is a diagram for explaining an example of an operation of an image formation controller 16;

FIG. 5 is a configuration diagram of a modified example of the exemplary embodiment of the invention;

FIGS. 6A and 6B are diagrams for explaining a specific example of an operation of the modified example of the exemplary embodiment of the invention; and

FIG. 7 is a diagram for explaining an example of a computer program, a storage medium storing the computer program, and a computer in the case where functions described in the exemplary embodiment and the modified example of the invention are implemented with the computer program.

### DETAILED DESCRIPTION

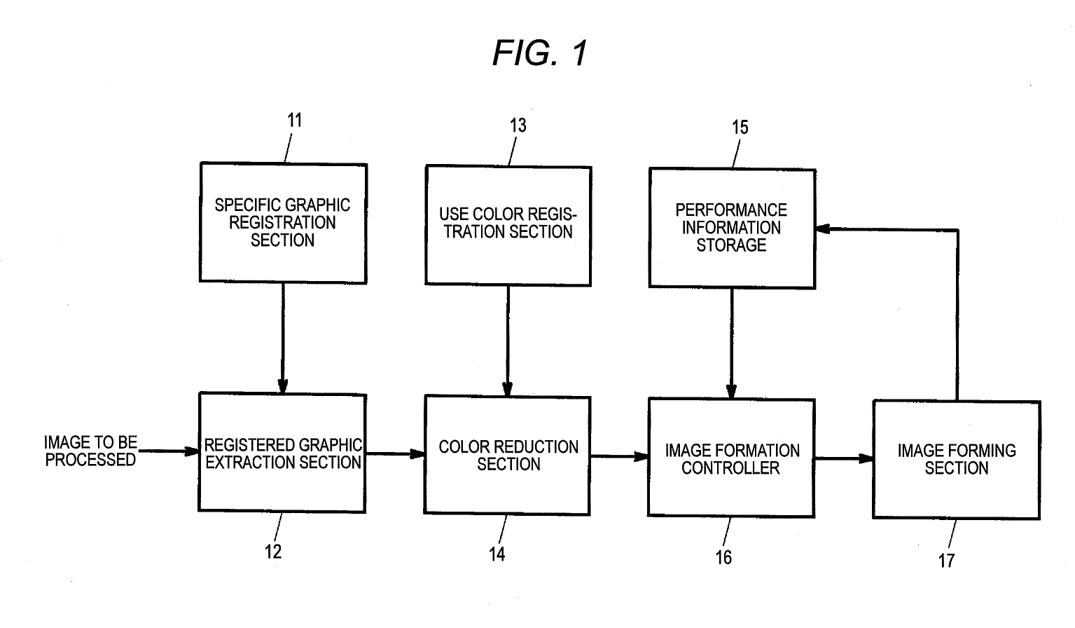

FIG. 1 is a configuration diagram showing an exemplary embodiment of the invention. In FIG. 1, reference numeral 11 is a specific graphic registration section, reference numeral 12 is a registered graphic extraction section, reference numeral 13 is a use color registration section, reference numeral 14 is a color reduction section, reference numeral 15 is a performance information storage, reference numeral 16 is an image formation controller, and reference numeral 17 is an image forming section. An image to be processed may be an image read with a reading device such as a scanner or a camera. The image to be processed may also be a raster image generated with software such as CG. Also, any coded information described in any descriptive language may be treated as an image to be processed. The image to be processed may be received by any known method such as receiving the image by reading from a storage medium or receiving the image from a reading device integrally installed, as well as receiving the image through a wired or wireless communication path.

A specific graphic is registered in the specific graphic registration section 11. The specific graphic is one for which a faithful color reproduction is required, such as an emblem (for example, so called a corporate logo) or sealing impression. Even the specific graphic may be an image read by a reading device such as a scanner or a camera, a raster image generated with software such as CG, or coded information described in any technology language. It is assumed that the specific graphic is the coded information. In this case, if the coded information contains a size, a color, and a character of the specific graphic, font information of the specific graphic may be set. Also, the number of the registered specific graphic is not limited to one, and plural specific graphics may be registered.

The registered graphic extraction section 12 extracts the specific graphic registered in specific graphic registration section 11 from the image to be processed. If both of the image to be processed and the specific graphic are raster images, the configuration, shape, color of the images are determined by a known method such as a pattern matching process to extract the specific graphic. Also, If the image to be processed is coded information and if the specific graphic is a raster image, a drawing process is performed for the image to be processed to obtain a raster image, and then the specific graphic may be extracted by the known method such as the pattern matching processing. If there is coded information to draw a raster image, the raster image may be compared with the specific graphic. If the image to be processed is a raster image and if the specific graphic is coded information, the drawing process is performed for the specific graphic to obtain a raster image, and the specific graphic may be extracted by the known method such as the pattern matching processing. If both of the image to be processed and the specific graphic are coded information, the specific graphic may be extracted by determining a size, a color or font information of the specific graphic with respect to the drawing graphic.

The use color registration section 13 registers a color(s) after a color(s) are reduced when the color reduction section 14 performs a color reduction process. For example, in the case where colors are reduced to two colors, for example, black and magenta, or black and red are registered. The color(s) to be registered may be a color(s) of color material(s) used in the image forming section 17. Also, if a use color(s) are determined in advance, the use color registration section 13 may be omitted.

For graphic other than the specific graphic extracted by the registered graphic extraction section 12, the color reduction section 14 limits the use color(s) to the color(s) registered in the use color registration section 13 so as to a process of reducing the number of color(s). The color reduction process may be performed by the known method.

The performance information storage 15 stores information about performance of the image forming section 17. In this exemplary embodiment, it is assumed that the performance information storage 15 stores at least information about the number of a color(s) of a color material(s) used in the image forming section 17. The performance information storage 15 may also store information about the color(s) of the color material(s). The performance information storage 15 may further store information about other performance as well. Also, in the configuration where the image formation controller 16 obtains information about performance from the image forming section 17, the performance information storage 15 may be omitted.

The image formation controller 16 controls the image forming section 17 to form the specific graphic and an image which is formed with the reduced number of color(s) according to the performance of image forming section 17, which is obtained from the information about the performance stored in the performance information storage 15. The performance of image forming section 17 may be obtained from the image forming section 17.

As the control for forming the images, for example, if the specific graphic is present, the image formation controller 16 controls the image forming section 17 to faithfully reproduce the color of the specific graphic. Also, if the specific graphic is not present, the image formation controller 16 controls the image forming section 17 to limit the color(s) of the color material(s) used in image forming section 17 to a color(s) reproducing the color(s) reduced by the color reduction section 14 (e.g., the color(s) registered in the use color registration section 13). For example, when colors are reduced to two colors of black and magenta, the image formation controller 16 may control the image forming section 17 to form an image using black and magenta.

Depending on the performance of the image forming section 17, even if the specific graphic is present, the image forming section 17 may not have performance of reproducing the color of the specific graphic. Also, even if the specific graphic is not present, the image forming section 17 may not have the performance of reproducing the color(s) which are the result of the color reduction process. In this case, a warning message may be issued to stop forming the image or following an instruction from a user. Alternatively, a process of color conversion or a process of tone conversion may be performed so that the color(s) are reproduced within the performance of the image forming section 17, and then the image forming section 17 may be caused to form the image.

The image forming section 17 forms an image received from the image formation controller 16 under the control of the image formation controller 16. The information about the performance of image forming section 17 is stored in the performance information storage 15 or is transmitted in response to a inquiry from the image formation controller 16. Further, the image forming section 17 may adopt any image forming method.

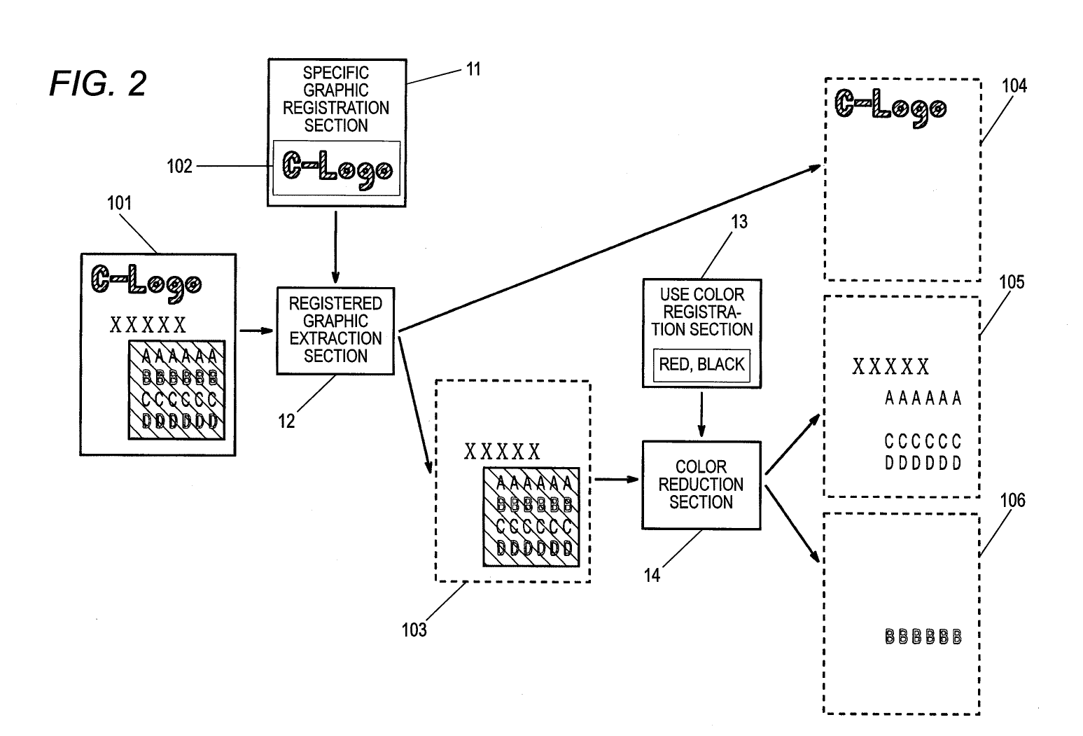

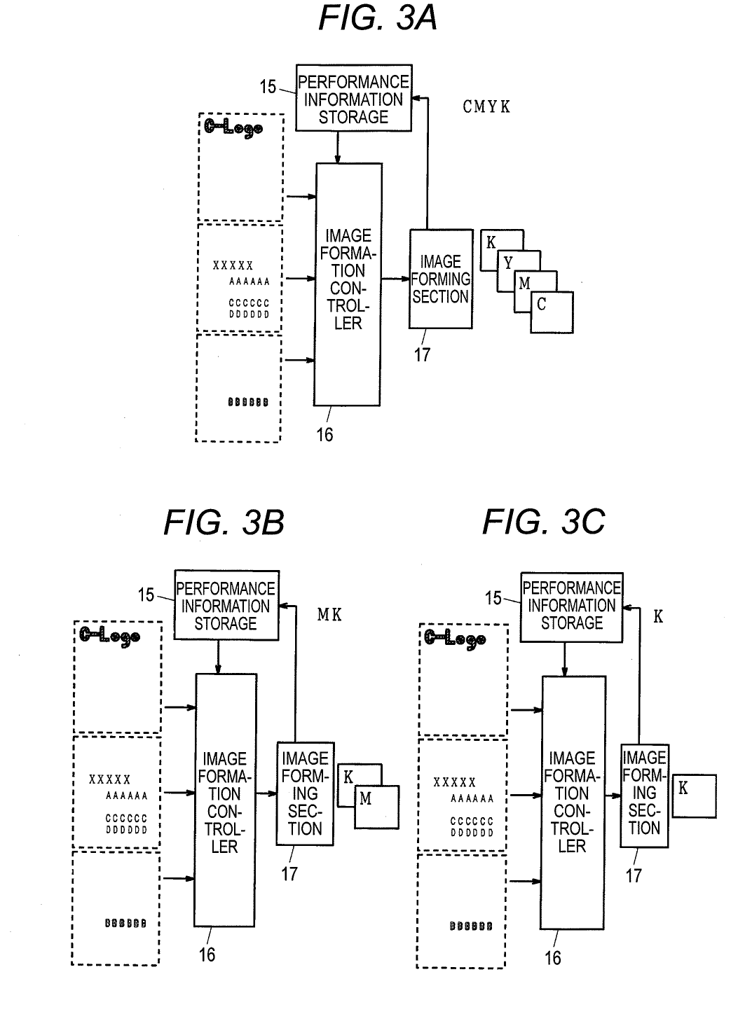

An example of an operation of the exemplary embodiment of the invention will be described based on specific examples. FIGS. 2 and 3A to 3C are diagrams for explaining a specific example of an operation in the exemplary embodiment of the invention. In FIG. 2, reference numeral 101 denotes a specific example of the image to be processed. It is assumed that, in the image 101 to be processed shown in FIG. 2, a cyan character ‘C-Logo’ which is a specific graphic and black characters ‘XXXXX’ are drawn and that black characters ‘AAAAAA’, red characters ‘BBBBBB’, black characters ‘CCCCCC’, and blue characters ‘DDDDDD’ are drawn in the background. Further, for the convenience of representing the color image 101 in the monochrome figure (FIG. 2), hatching indicates a background color, and different fonts indicate the different colors of the respective characters.

It is also assumed that a graphic (e.g., a raster image or coded information) of the character ‘C-Logo’ of a specific color is registered in the specific graphic registration section 11 as indicated by reference numeral 102. The registered graphic extraction section 12 extracts the specific graphic 102, which is registered in the specific graphic registration section 11, from the image 101 to be processed. In this specific example, the character ‘C-Logo’ is extracted. The extracted specific graphic is shown in a dashed-line box 104. Portions of the image 101 to be processed other than the specific graphic are shown in a dashed-line box 103.

In this example, the specific graphic in the dashed-line box 104 and the portions of image to be processed other than the specific graphic in the dashed-line box 103 are shown as separate images. However, a tag may be added to the image 101 to be processed to distinguish the specific graphic and the portions of the image to be processed other than the specific graphic.

It is assumed that red and black are registered in the use color registration section 13. As the registration of the use color(s), a color(s) other than black may be registered in the use color registration section 13 from an outside. Alternatively, when the color reduction is instructed as an operation mode or when an operation mode including the color reduction is set, a color(s) corresponding to the operation mode may be registered in the use color registration section 13. Also, a color(s) may be registered in the use color registration section 13 so that the registered color(s) are within a range of colors reproduced with the color(s) of the color material(s) used in the image forming section 17.

The color reduction section 14 performs the color reduction process for the image other than the specific graphic shown in the dashed-line box 103 so that a color(s) are reduced to the use color(s) registered in the use color registration section 13. In this example, it is assumed that the colors are reduced to two colors of red and black. By the color reduction process, the blue characters are converted into black and the background color is removed, which leads to a black image shown in a dashed-line box 105 and a red image shown in a dashed-line box 106.

In this example, it is assumed that the performance information storage 15 store the information about the color material(s) which the image forming section 17 uses to form an image. The image formation controller 16 controls the image forming section 17 according to the information about the performance stored in performance information storage 15 and causes the image forming section 17 to form an image.

For example, in an example shown in FIG. 3A, the image forming section 17 has the performance of forming a full-color image using color materials of four colors. In the case where an image is formed using such an image forming section 17, the image formation controller 16 causes the image forming section 17 to form an image for the specific graphic with a designated color and to form a color-reduced image with black and red in this example. Even though the color reduction process is performed, deterioration in quality for the specific graphic is not caused. Also, an amount of the color material(s) for the portions other than the specific graphic is reduced by the color reduction process. If the color of the specific graphic is a color that cannot be reproduced by the color material(s) used in the image forming section 17, the color of the specific graphic may be converted, for example, by a color conversion into a color which can be reproduced and an image is formed. Alternatively, a notification indicating that the color of the specific graphic cannot be reproduced may be output.

For example, in an example shown in FIG. 3B, the image forming section 17 has the performance of forming an image with color materials of two colors, that is, black and magenta (M). When an image is formed using such an image forming section 17, the image formation controller 16 causes the image forming section 17 forms a color-reduced image with two colors of black and magenta instead of the two colors of black and red in this example. Also, since the color (cyan) designated for the specific graphic is not reproduced, the color designated for the specific graphic may be converted into magenta or a color obtained by using magenta and black. Alternatively, a notification indicating that the color designated for the specific graphic cannot be reproduced may be output. If the image forming section 17 has the performance of forming an image with the color materials of black and cyan, the specific graphic is reproduced with cyan, and then red being one of the colors (black and red) to which colors are reduced may be converted into cyan for reproduction. In the case of putting an importance on the reproduction of the specific graphic, the color material of the color of a the specific graphic or a color material(s) reproducing the color of the specific graphic is provided in the image forming section 17. In this case, the color of the specific graphic is reproduced, and then a color(s) to which colors are reduced to are converted. In any case, the image formation controller 16 controls the image forming section 17 according to the color(s) of the color material(s), which are used in the image forming section 17 to form an image, so as to form the specific graphic and the color-reduced image.

In an example shown in FIG. 3C, the image forming section 17 forms an image with a black color material. In this case, since all images are formed only with black (gray), both of the specific graphic and the color-reduced image are formed with black (gray). Alternatively, a notification indicating that the color of the specific graphic cannot be reproduced may be output.

The performance of the image forming section 17 is not limited to the examples shown in FIGS. 3A to 3C. For example, the image forming section 17 may have, for example, performance of forming an image using color materials of three colors or five or more colors, and may use color materials of any colors. Also, when the specific graphic is not included in the image to be processed, the color-reduced image may be formed. For example, when colors are reduced to two colors, the image forming section 17 may form an image of two colors with color materials of two or more colors.

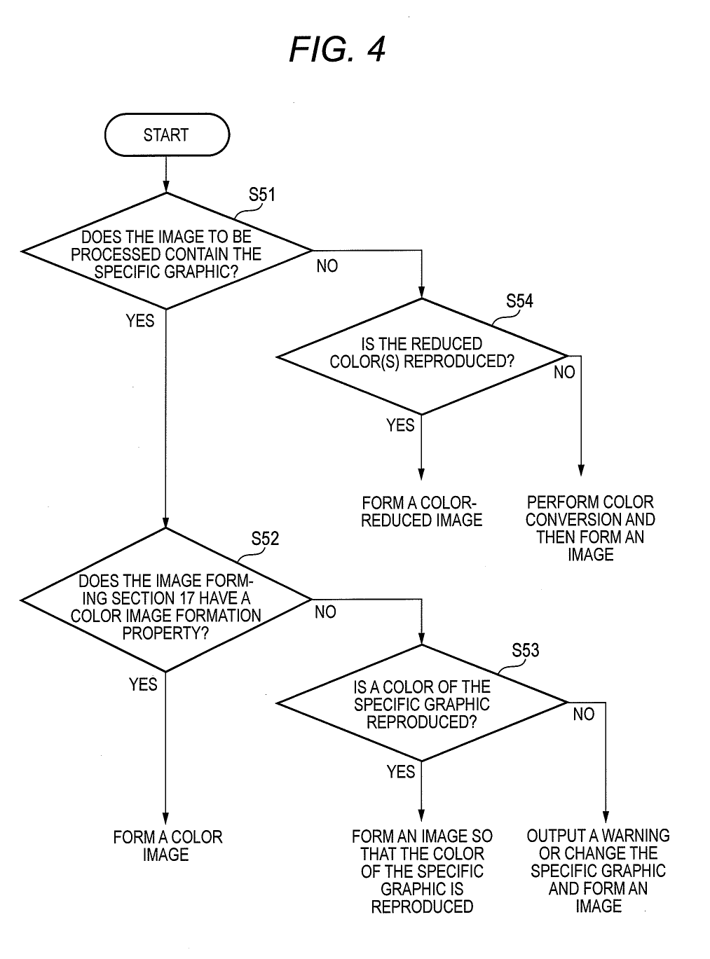

FIG. 4 is a diagram for explaining an example of an operation of the image formation controller 16. The flowchart shown in FIG. 4 is obtained by summarizing the operation of the image formation controller 16, which has been described with reference to FIG. 3. That is, at S51, the image formation controller 16 determines as to whether or not a specific graphic is included in an image to be processed. If so, the image formation controller 16 presumes that a color image will be formed. Then, at S52, the image formation controller 16 determines the performance information about the image forming section 17, which is acquired from the performance information storage 15. If the image forming section 17 has a performance of forming a color image with three or more color materials, the image formation controller 16 causes the image forming section 17 to form the specific graphic and the color-reduced image. Color conversion corresponding to the colors of the color materials, which are used in the image forming section 17, may be performed, and thereafter the image forming section 17 may form the image.

If the image forming section 17 does not have the performance of forming a color image, at S53, the image formation controller 16 determines as to whether or not the color material(s), which are used in the image forming section 17, can reproduce the color of the specific graphic. For example, there is a case where the color material of the color of the specific graphic is provided in the image forming section 17 or a case where the color of the specific graphic is reproduced by color materials of plural colors. In this case, the color of the specific graphic is reproduced and is formed together with the color-reduced image. In this case, the color reproduction process or a color conversion may be further performed for the color-reduced image.

If the image formation controller 16 determines at S53 that the color of the specific graphic is not reproduced, the image formation controller 16 outputs the warning message indicating so. Alternatively, the color of the specific graphic may be converted according to the image forming section 17 for output. Further alternatively, the specific graphic may be changes so that the change result can be understood as indicating the specific graphic, and the image forming section 17 may form the change result together with the color-reduced image. Also, if the image formation controller 16 determines at S52 that the color of the specific graphic is a color that is not reproduced by the image forming section 17, this situation may be regarded as the case where the image formation controller 16 determines at S53 that the color of the specific graphic is not reproduced.

If the image formation controller 16 determines at S51 that the specific graphic is not included in the image to be processed, at S54, the image forming controller 16 determines the information about the performance of the image forming section 17, which is acquired from the performance information storage 15, and determines as to whether or not a color(s) of a color-reduced image is reproduced. For example, if colors are reduced to two colors and if the two colors are reproduced in a distinguished manner, the image forming section 17 may form an image so that the two colors are recognizable. If the color-reduced image is not reproduced by the image forming section 17, the color-reduced image may be converted so that it is reproduced by the image forming section 17, and the image forming section may form the image. For example, if the respective colors to which the colors are reduced are reproduced in a distinguished manner, a color(s) of the color-reduced image may be converted into a color(s) which are reproduced by the image forming section 17, and then the image forming section 17 may form the image. Also, if the image forming section 17 is an apparatus for forming a monochromic image, the color-reduced image is converted into, for example, an image having different tone levels, and the image forming section 17 may form the converted image with the single color.

In the above-mentioned example, the color reduction process has been performed for the portions of the image to be processed other than the specific graphic. Therefore, for example, when charging is introduced, a user may be charged for the forming of the color-reduced image even if the specific graphic is a full-color graphic. Also, whether or not the specific graphic is handled distinctively from the other portions of the image to be processed may be switched based on whether or not the image to be processed includes a specific graphic. Alternatively, a user may select as to whether or not the specific graphic is handled distinctively from the other portions of the image to be processed. For example, a specific graphic mode may be prepared together with, for example, a full color mode, a color reduction mode or a black and white mode. In the specific graphic mode, the specific graphic may be formed with the full colors and the portions of the image to be processed other than the specific graphic may be formed with colors being reduced.

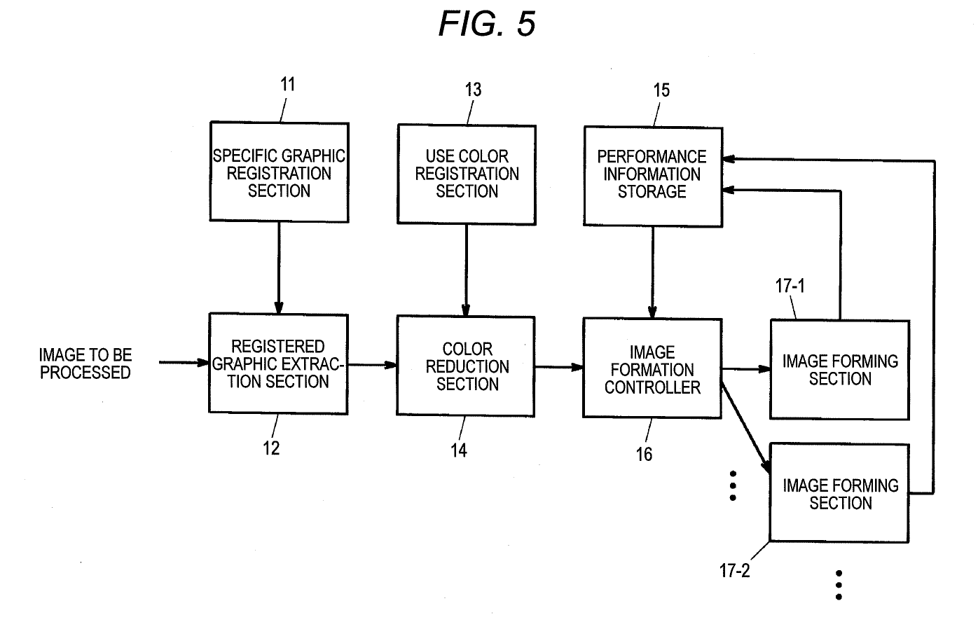

FIG. 5 is a configuration diagram showing a modified example of the exemplary embodiment of the invention. In FIG. 5, reference numerals 17-1 and 17-2 denote image forming sections. In this modified example, plural image forming sections are provided. Although FIG. 5 shows the two image forming sections 17-1 and 17-2, three or more image forming sections may be provided.

In this configuration, the performance information storage 15 stores information about performance of each of the image forming sections 17-1 and 17-2. Also, the image formation controller 16 generates and outputs an image that can be formed by either the image forming sections 17-1 or 17-2, based on the information about the performance of the image forming sections 17-1 and 17-2, which are stored in the performance information storage 15. In this case, even if the image is formed by either the image forming sections 17-1 or 17-2, the same result would be achieved. Alternatively, the image formation controller 16 selects one of the image forming sections 17-1 and 17-2 based on the information about the performance of the image forming sections 17-1 and 17-2, which are stored in the performance information storage 15, and controls the selected one to form an image. For example, if the color of the specific graphic is reproduced by one of the image forming sections 17-1 and 17-2, the image formation controller 16 selects and causes the one of the image forming sections 17-1 and 17-2, which can reproduce the color of the specific graphic, to form the image.

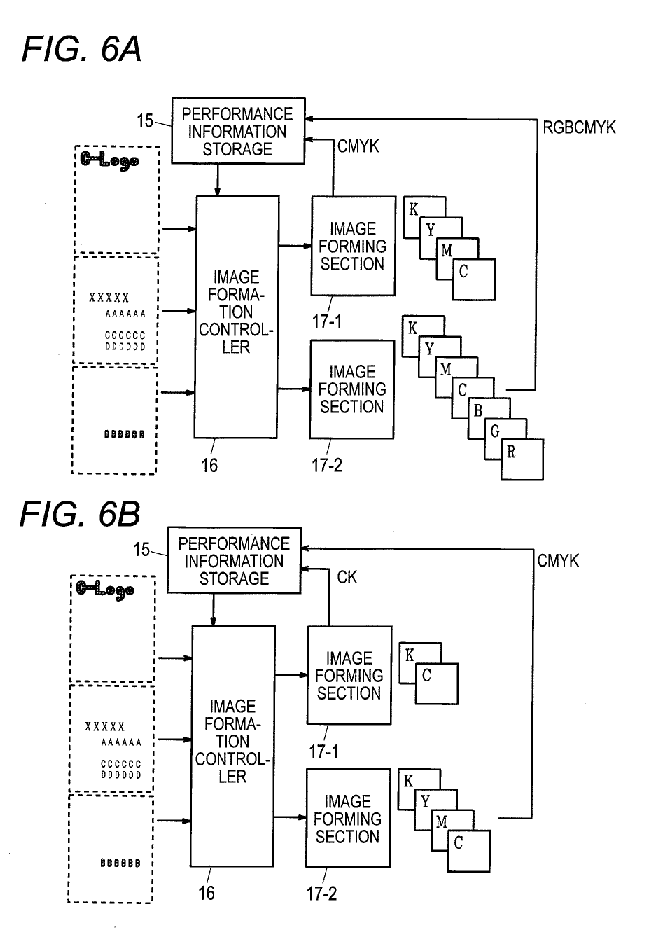

An example of the operation of the modified example according to the exemplary embodiment of the invention will be described with reference to specific examples. It is assumed that the processes up to the color reduction section 14 are the same as those in the specific example shown in FIG. 2. FIGS. 6A and 6B are diagrams for explaining the specific examples of the operation of the modified example according to the exemplary embodiment of the invention. In an example shown in FIG. 6A, the image forming section 17-1 has the performance of forming a full-color image with color materials of four colors, and image forming section 17-2 has the performance of forming a full-color image with color materials of seven colors. It is assumed that an image is formed by using such image forming sections 17-1 and 17-2. The image formation controller 16 instructs to form the image of the specific graphic with the color designated for the specific graphic and to form the color-reduced image with, for example, black and red in this example. However, since there is a difference in performance between the two image forming sections 17-1 and 17-2, the image formation controller 16 causes the image forming sections 17-1 and 17-2 to form the images in accordance with an image quality of the image forming section 17-1, which has the lower performance than the image forming section 17-2. As a result, the same image quality can be achieved by using either the image forming sections 17-1 or 17-2.

There is a case where although the color of the specific graphic is not reproduced by the image forming section 17-1, it is reproduced by the image forming section 17-2. In this case, the color of the specific graphic may be converted so that it is reproduced by the image forming section 17-1, and the image forming section 17-1 may form the image. Also, the image forming section 17-2 may form the image having the converted color in parallel with the image forming section 17-1. Alternatively, the image formation controller 16 may select the image forming section 17-2, which can reproduce the color of the specific graphic, and control the image forming section 17-2 to form the image.

In an example shown in FIG. 6B, the image forming section 17-1 has a performance of forming an image with color materials of two colors of black and cyan (C), and the image forming section 17-2 has a performance of forming a full-color image with color materials of four colors. When images are formed by such image forming sections 17-1 and 17-2, while the image forming section 17-1 can reproduce a color (cyan) designated for a specific graphic, it cannot reproduce red of an image in which colors have been reduced to black and red. When both of the image forming sections 17-1 and 17-2 operate in parallel, red is converted into cyan, black or a color obtained by using cyan and black, and the image forming sections 17-1 and 17-2 may form the images together with the specific graphic. Alternatively, the image formation controller 16 may select the image forming section 17-2, which can reproduce black and red to which colors have been reduced as well as the color (cyan) of the specific graphic, and cause the image forming section 17-2 to form the image.

If the image forming sections 17-1 and 17-2 operated in parallel and if there is a color that is not reproduced in at least one of the image forming sections 17-1 and 17-2, the image formation controller 16 may output a notification indicating so. Then, the image formation controller 16 may receive an instruction indicting as to whether the image formation is stopped or an image is formed with the color in question being converted into another color.

In the above description, the two examples have been described as the examples of the performance of the image forming sections 17-1 and 17-2. However, the performance of the image forming sections 17-1 and 17-2 and the combination of the image forming sections 17-1 and 17-2 are not limited to the above examples. For example, the image formation of the image forming sections 17-1 and 17-2 may be controlled according to (i) the color of the specific graphic, (ii) the reduced colors and (iii) whether or not the image forming sections 17-1 and 17-2 operate in parallel.

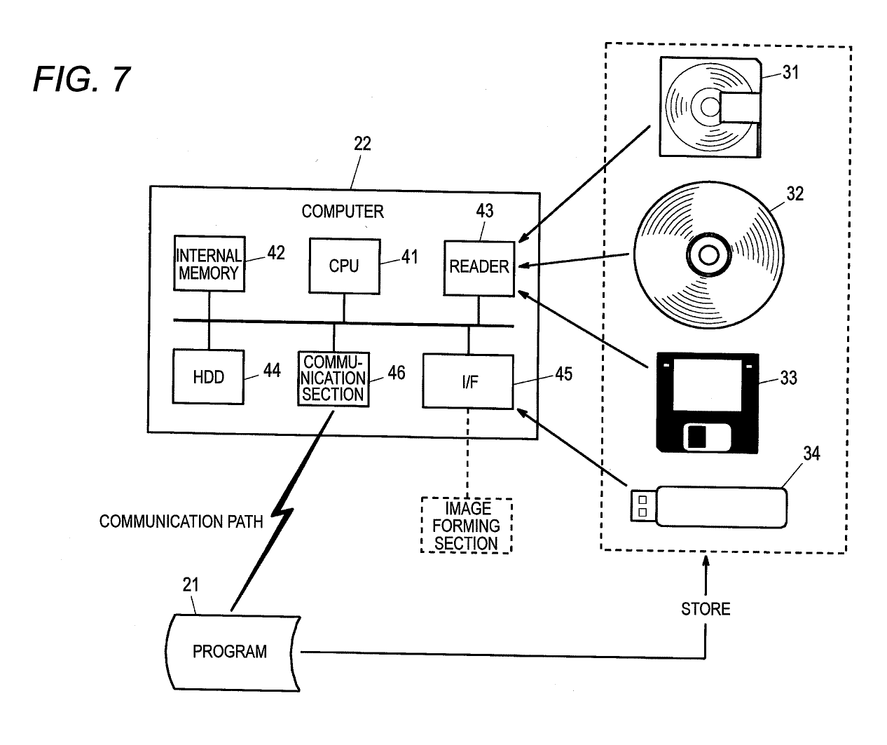

FIG. 7 is a diagram illustrating an example of a computer program implementing the functions described in the exemplary embodiment and the modified embodiments of the invention, a storage medium storing the computer program, and a computer. Various components are illustrated in FIG. 7 including a program 21, a computer 22, a magneto-optical disc 31, an optical disc 32, a magnetic disc 33, a memory 34, a CPU 41, an internal memory 42, a reader 43, a hard disc 44, an interface 45, and a communication section 46.

All or a portion of the functions of the respective sections described in the exemplary embodiment and the modified examples as described above may be implemented by the program 21 running on the computer 22. In this case, the program 21 and data used by the program 21 may be stored in a storage medium which is readable by the computer 22. The storage medium causes a change state of energy such as magnetism, light and electricity in response to described contents of the program and transfers the described contents of the program to the reader 43, which is provided in the hardware resources of the computer 22, according to the contents of the program, in a corresponding signal format. Examples of the storage medium include the magneto-optical disc 31, the optical disc 32 (e.g., CD or DVD), the magnetic disc 33, memory the 34 (e.g., an IC card, a memory card, or a flash memory). These storage medium is not limited to a portable type.

The program 21 may be stored in the storage medium which is mounted in, for example, the reader 43 or the interface 45 of computer 22, so that the program 21 is read by the computer 22 and is then stored in the internal memory 42 or the hard disc 44 (e.g., a magnetic disc or a silicon disc). The program 21 may then be executed by the CPU 41 so that all or a portion of the functions described in the exemplary embodiment and the modified example of the invention are implemented. Alternatively, the program 21 may be transmitted to the computer 22 through a communication path, and received in the communication section 46 of the computer 22 to store the program 21 in the internal memory 42 or the hard disc 44. The program 21 may then be executed by the CPU 41.

The computer 22 may be connected to several devices through the interfaces 45. For example, the image forming sections 17, 17-1 and 17-2 may be connected through the interface 45. Further, a display device that displays information and/or a receiving device that receives information from a user may also be connected to the computer 22. Also, the image to be processed may be read with an image reading device connected through the interface 45 or may be received by the communication section 46 through the communication path. Further, the image may also be read from the storage medium or received from another program running on the computer 22.

A portion or all of the functions may be implemented by hardware. Alternatively, together with other elements, a program including all or a portion of the functions described in the exemplary embodiment and the modified example of the invention may be provided. Further, when the program is applied to another usage, the program may be integrated with a program corresponding to said another usages.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing apparatus, comprising:
a graphic registration unit in which a specific graphic is registered;
a registered graphic extraction unit that extracts, from an image to be processed, the specific graphic registered in the graphic registration unit;
a color reduction unit that reduces the number of colors used for a portion of the image to be processed other than the specific graphic; and
an image formation controller that controls an image forming apparatus to form the specific graphic and the portion of the image to be processed in which the number of the colors is reduced, according to a performance of the image forming apparatus.

2. The image processing apparatus according to claim 1, wherein when the image to be processed contains the specific graphic, the image formation controller controls the image forming apparatus to form the specific graphic with a color designated for the specific graphic.

3. The image processing apparatus according to claim 1, wherein when the image to be processed does not contain the specific graphic, the image formation controller controls the image forming apparatus so as to limit colors of color materials, which are used in the image forming apparatus, to colors to which the color reduction unit has reduced.

4. The image processing apparatus according to claim 1, wherein the image formation controller obtains information about performances of a plurality of image forming apparatuses, and generates and outputs an image which can be formed by any one of the plurality of image forming apparatuses.

5. The image processing apparatus according to claim 1, wherein
the image formation controller obtains information about performances of a plurality of image forming apparatuses, and
when the image to be processed contains the specific graphic, the image forming controller selects an image forming apparatus that reproduces a color designated for the specific graphic from the plurality of image forming apparatuses.

6. An image forming apparatus comprising:
the image processing apparatus according to claim 1; and
a forming unit that forms an image received from the image formation controller under control of the image formation controller of the image processing apparatus.

7. A non-transitory computer readable recording medium storing a program that causes a computer to execute image processing, wherein
a specific graphic is registered in a storage;
the image processing comprises:
extracting, from an image to be processed, the specific graphic registered in the storage;
reducing the number of colors used for a portion of the image to be processed other than the specific graphic; and
controlling an image forming apparatus to form the specific graphic and the portion of the image to be processed in which the number of the colors is reduced, according to a performance of the image forming apparatus.
